(19) United States
(12) Patent Application Publication
(10) Pub. No.: US 2024/0421955 A1
(43) Pub. Date: Dec. 19, 2024

(54) POSITIONING SCHEMES IN WIRELESS COMMUNICATIONS

(71) Applicant: ZTE Corporation, Shenzhen (CN)

(72) Inventors: Focai PENG, Shenzhen (CN); Chuangxin JIANG, Shenzhen (CN); Mengzhen LI, Shenzhen (CN); Cong WANG, Shenzhen (CN); Qi YANG, Shenzhen (CN); Junpeng LOU, Shenzhen (CN)

(21) Appl. No.: 18/816,686

(22) Filed: Aug. 27, 2024

Related U.S. Application Data
(63) Continuation of application No. PCT/CN2023/072729, filed on Jan. 17, 2023.

(51) Int. Cl. H04L 5/00

(52) U.S. Cl. CPC H04L 5/0051; H04L 5/0005; H04L 5/0094

(57) ABSTRACT

Methods, apparatus and system for wireless communication are described. One method of wireless communication is provided. The method comprises: receiving, by a user device from a network device, configuration information that configures a positioning reference signal; performing a measurement on the positioning reference signal; and reporting a measurement result of the measurement.

### CROSS REFERENCE TO RELATED APPLICATIONS

This patent document is a continuation of and claims benefit of priority to International Patent Application No. PCT/CN2023/072729, filed on Jan. 17, 2023. The entire content of the before-mentioned patent application is incorporated by reference as part of the disclosure of this application.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient system evolution.

### SUMMARY

Various methods and apparatus for providing positioning schemes in a wireless communication system are provided.

In one example aspect, a method of wireless communication is disclosed. The method includes receiving, by a user device from a network device, configuration information that configures a positioning reference signal; performing a measurement on the positioning reference signal; and reporting a measurement result of the measurement.

In another example aspect, a method of wireless communication is disclosed. The method includes configuring, by a base station, a reference signal for positioning; performing a measurement on the reference signal for positioning; and reporting a measurement result of the measurement.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an example diagram to illustrate a downlink (DL) positioning scheme.

FIG. 2 shows an example diagram to illustrate an uplink (UL) positioning scheme.

FIG. 3 illustrates a graph indicating an accuracy of position for UEs supporting hopping.

FIG. 4 illustrates an example of transmissions of SRS including first to fifth partial transmissions based on some implementations of the disclosed technology.

FIG. 5 illustrates an example of hopping pattern with two allocated symbols based on some implementations of the disclosed technology.

FIG. 6 illustrates an example of resources that are transmitted with two symbols on a first antenna and a second (virtual) antenna based on some implementations of the disclosed technology.

FIG. 7 is a block diagram of an example of a wireless communication apparatus.

FIG. 8 shows an example wireless communications network.

FIGS. 9 and 10 are example flowcharts of wireless communication methods based on some implementations of the disclosed technology.

### DETAILED DESCRIPTION

The disclosed technology provides implementations and examples of positioning schemes with improved positioning accuracy for RedCap UEs.

Section headings are used in the present document only to improve readability and do not limit scope of the disclosed embodiments and techniques in each section only to that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

Currently, there exists some requirements on positioning. For example, in a park (especially, an underground park), it is not easy to find a car (especially, during busy hour). The 5^{th} Generation mobile communication system (5G, New Radio access technology, 5G-NR) provides a method on positioning, including, Positioning Reference Signal (PRS, from base station, gNB) and Sounding Reference Signal (SRS, from User equipment, UE) on radio side.

Some implementations of the disclosed techniques may be used to support a class of NR UEs with complexity and power consumption levels lower than Rel-15 NR UEs. A class of Reduced Capability (RedCap) NR User Equipment (UE) is expected to be defined that can be served using the currently specified 5G NR framework with necessary adaptations and enhancements to limit device complexity and power consumption while minimizing any adverse impact to network resource utilization, system spectral efficiency, and operation efficiency.

For a reduced capability (RedCap) UE, there are limitations on receiving/transmitting bandwidth, for example, 20 MHz in frequency range one (FR1). In some examples, the receiving/transmitting bandwidth can be limited even to 5 MHz in 700 MHz band. The positioning accuracy is highly related to the bandwidth of Reference Signal for Positioning. In some cases, a RedCap UE has only one receiving/transmitting antenna (e.g., in frequency range one, FR1), which also causes to decrease the positioning accuracy.

The positioning accuracy of the existing 5G-NR-based positioning solutions for RedCap UE may not be high enough (e.g., 3 meters or worse). In some harsh environment (e.g., dense urban area), the positioning accuracy of the existing 5G-NR-based positioning solution for RedCap UE might be even worse. In some commerce cases, a positioning accuracy of one meter is required. In some cases, the target of some commerce requirements (e.g., one meter) is hard to be achieved by the existing 5G-NR-based positioning solution for RedCap UE. In this regard, some implementations of the disclosed technology relate to techniques for positioning accuracy improvements for 5G-NR-based positioning, especially, for RedCap UE.

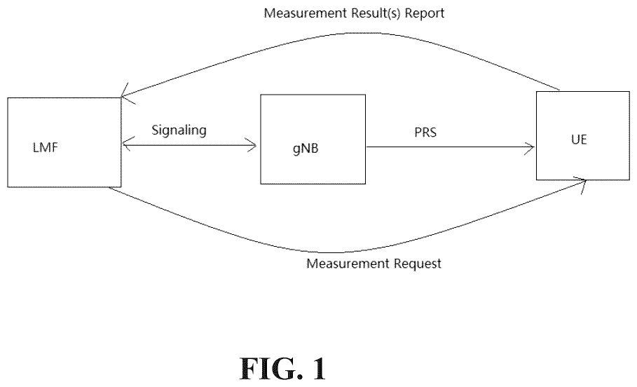

FIG. 1 shows an example diagram to illustrate a downlink (DL) positioning scheme. In the downlink (DL) positioning as shown in FIG. 1, the PRS is transmitted by one or multiple gNBs. In some examples, multiple gNBs are involved to achieve a “good” positioning accuracy. In some examples, three base stations are used. The number of multiple gNBs is not limited to three and other implementations are also possible. A UE measures PRS (Positioning Reference Signal) and reports the measurement result(s) to network (e.g., a Location Management Function, LMF, in the Core Network, CN, 5G CN, 5GC). It should be noted that, network element includes gNB, CN and UE. In some implementations, the UE can concatenate segments (hops) of the PRS and performs the measurement on the concatenated PRS.

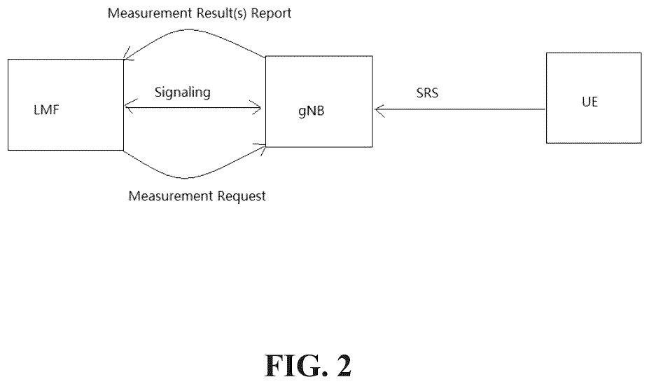

FIG. 2 shows an example diagram to illustrate an uplink (UL) positioning scheme. In the uplink (UL) positioning as shown in FIG. 2, the SRS is transmitted by one UE. One or multiple gNBs measure the SRS and report the measurement result(s) to network (e.g., LMF).

The transmission of PRS and SRS for purpose of positioning is easily affected by the radio propagation environment (e.g., fading, distortion), which may cause to decrease the positioning accuracy.

Various implementations of the disclosed technology provide positioning schemes with improved positioning accuracy as compared to those available in the conventional art. As a RedCap UE can only support limited bandwidth (e.g., 20 MHz or 5 MHz in FR1), multiple segments (hops) can be applied to a RedCap UE. The segment (hop) may refer to a transmission of a reference signal on one specific frequency range at one specific time. The following is the example of two segment (two hops) when a first segment (hop) is transmitted on 2000 MHz to 2020 MHz (with 20 MHz bandwidth) at the first milli-second and then after a while, a second segment (hop) is transmitted on 2020 MHz to 2040 MHZ (with 20 MHz bandwidth) on the second milli-second. A RedCap UE can receive/transmit multiple hops on different frequencies and different times to form an equivalent high bandwidth. For frequency hopping (including transmission hopping and reception hopping), some undesired issues such as random phase at each hop, large time delay, etc. can may arise. Some implementations of the disclosed technology provide techniques to avoid and/or overcome the undesired issues.

### Implementation Example 1: UL-SRS Hopping/DL-PRS Hopping

In the description below, the SRS transmission is used as an example, but the suggested implementation can be applied to the PRS transmission as well. When the implementation is applied to the SRS transmission, it might be referred to as UL-SRS hopping. When the implementation is applied to the PRS transmission, it might be referred to as DL-PRS hopping.

For a RedCap UE, the SRS transmission (or PRS transmission) can be hopped or non-hopped on frequency within an active bandwidth part (BWP). The hopping may refer to an event when a transmission is passed from one range to another range of bandwidth or frequency. Since the SRS transmission (or PRS transmission) is hopped within the active BWP, the bandwidth range (or frequency range) after the hopping is within an active BWP.

For each SRS transmission (or PRS reception), there is a downlink control information (DCI) to trigger the SRS transmission (or PRS reception). In some implementations, there is only one DCI to trigger all the SRS transmission with hopping (or all the PRS reception with hopping. i.e., one DCI for all hops). In some implementations, a bitmap on a DCI will indicate which hop of SRS transmission (or PRS reception) is triggered. In some implementations, a codepoint (e.g., ‘0’, ‘1’, ‘2’, ‘3’ for the possible codepoint of two bits) on a DCI will indicate which hop of SRS transmission (or PRS reception) is triggered. In some implementations, a medium access control (MAC) control element (CE) will indicate which hop of SRS transmission (or PRS reception) is triggered.

In some implementations, there is a transmission window (or transmission gap, e.g., a time duration/period, e.g., 20 ms, 40 time slots) for hopped SRS transmission. The gNB (or LMF) can configure this transmission window. If this transmission window were not configured, a RedCap UE will not perform a hopped SRS transmission outside of its working bandwidth (e.g., 20 MHz. e.g., by a normal non-hopped SRS transmission within its working bandwidth). In some implementations, a MAC CE can enable/disable the transmission window. In some implementations, a UE can request this MAC CE to enable/disable the transmission window. In some implementations, a UE can request a MAC CE on hopped SRS transmission.

For a case with sub-carrier spacing (SCS)=15 kHz and 50 MHz bandwidth, there are NRB=270 RBs (RB #0, 1, 2, . . . 268, 269)). The RB #0 can be the common RB, CRB, or CRB0. For a case with SCS-15 kHz and 100 MHz bandwidth, there are NRB=2*270=540 RB (RB #0, 1, 2, . . . 268, 269, 270, 271, . . . 539). For a case with SCS=15 kHz and 20 MHz bandwidth support of a RedCap UE, to support an aggregated bandwidth of 100 MHz after hopping, there will be NHopping=5 hops with one or multiple overlapped RBs between two contiguous hops. The RBs of the first hop (of a RedCap UE) can be RB #0, 1, 2 . . . 103 (relative to CRB, or CRB0, 104 RB for PRS/SRS in total). A BWP or virtual BWP or a first BWP or a first virtual BWP can be configured with these RBs.

In addition, the bandwidth of PRS/SRS is not larger than that of a BWP. In some implementations, a hop is transmitted/received within a BWP or virtual BWP. The RBs of the second hop (of a RedCap UE) can be RB #103, 104, 105 . . . 206 (relative to CRB, or CRB0, with one overlapped RB on RB #103 over the previous hop and one overlapped RB on RB #206 over the next hop). A BWP or virtual BWP or a second BWP or a second virtual BWP can be configured with these RBs.

The RBs of the third hop (of a RedCap UE) can be RB #206, 207, 208 . . . 309 (relative to CRB, or CRB0, with one overlapped RB on RB #206 over the previous hop. A BWP or virtual BWP or a third BWP or a third virtual BWP can be configured with these RB). The RBs of the fourth hop (of a RedCap UE) can be RB #309, 310, 311 . . . 412 (relative to CRB, or CRB0, or virtual CRB, or virtual CRB0, with one overlapped RB on RB #309 over the previous hop. A BWP or virtual BWP or a fourth BWP or a fourth virtual BWP can be configured with these RB). The RBs of the fifth hop (of a RedCap UE) can be RB #412, 413, 414 . . . 515 (relative to CRB, or CRB0, with one overlapped RB on RB #412 over the previous hop. A BWP or virtual BWP or a fifth BWP or a fifth virtual BWP can be configured with these RB).

In some implementations, the sub-carrier of a hopped SRS transmission (or hopped PRS reception) starts from the lowest sub-carrier of the BWP it belongs to.

For a case with SCS=30 kHz and 100 MHz bandwidth, there are NRB=273 RB (RB #0, 1, 2 . . . 271, 272. The RB #0 can be the common RB, CRB, or, CRB0). For a case with SCS=30 kHz and 20 MHz bandwidth support of a RedCap UE, to support an aggregated bandwidth of 100 MHz after hopping, there will be NHopping=5 hops with one or multiple overlapped RB between two contiguous hops. The RBs of the first hop (of a RedCap UE) can be RB #0, 1, 2 . . . 54 (relative to CRB, or CRB0, 55 RB in total. A BWP or virtual BWP or a first BWP or a first virtual BWP can be configured with these RB). The RBs of the second hop (of a RedCap UE) can be RB #54, 55, 56 . . . 108 (relative to CRB, or CRB0, with one overlapped RB on RB #54 over the previous hop and one overlapped RB on RB #108 over the next hop. A BWP or virtual BWP or a second BWP or a second virtual BWP can be configured with these RB). The RBs of the third hop (of a RedCap UE) can be RB #108, 109, 110 . . . 162 (relative to CRB, or CRB0, with one overlapped RB on RB #108 over the previous hop. A BWP or virtual BWP or a third BWP or a third virtual BWP can be configured with these RB). The RBs of the fourth hop (of a RedCap UE) can be RB #162, 163, 164 . . . 216 (relative to CRB, or CRB0, with one overlapped RB on RB #162 over the previous hop. A BWP or virtual BWP or a fourth BWP or a fourth virtual BWP can be configured with these RB). The RBs of the fifth hop (of a RedCap UE) can be RB #216, 217, 218 . . . 270 (relative to CRB, or CRB0, with one overlapped RB on RB #216 over the previous hop. A BWP or virtual BWP or a fifth BWP or a fifth virtual BWP can be configured with these RB).

In some implementations, the start RB ID of the first hop can be shifted to 1 (i.e., RB #1). In some implementations, the RBs of the first hop (of a RedCap UE) can be RB #1, 2, 3, . . . 55 (relative to CRB, or CRB0, 55 RB in total). The RBs of the second hop (of a RedCap UE) can be RB #55, 56, 57, . . . 109 (relative to CRB, or CRB0, with one overlapped RB on RB #55 over the previous hop). The RBs of the third hop (of a RedCap UE) can be RB #109, 110, 111, . . . 163 (relative to CRB, or CRB0, with one overlapped RB on RB #109 over the previous hop). The RBs of the fourth hop (of a RedCap UE) can be RB #163, 164, 165, . . . 217 (relative to CRB, or CRB0, with one overlapped RB on RB #163 over the previous hop). The RBs of the fifth hop (of a RedCap UE) can be RB #217, 218, 219, . . . 271 (relative to CRB, or CRB0, with one overlapped RB on RB #217 over the previous hop).

In some implementations, the start RB ID of the first hop can be shifted to 2 (i.e., RB #2). In some implementations, the RBs of the first hop (of a RedCap UE) can be RB #2, 3, 4, . . . 56 (relative to CRB, or CRB0, 55 RB in total). The RBs of the second hop (of a RedCap UE) can be RB #56, 57, 58, . . . 110 (relative to CRB, or CRB0, with one overlapped RB on RB #56 over the previous hop). The RBs of the third hop (of a RedCap UE) can be RB #110, 111, 112, . . . 164 (relative to CRB, or CRB0, with one overlapped RB on RB #110 over the previous hop). The RBs of the fourth hop (of a RedCap UE) can be RB #164, 165, 166, . . . 218 (relative to CRB, or CRB0, with one overlapped RB on RB #164 over the previous hop). The RBs of the fifth hop (of a RedCap UE) can be RB #218, 219, 220, . . . 272 (relative to CRB, or CRB0, with one overlapped RB on RB #218 over the previous hop).

In some implementations, the bandwidth (in number of RB) of a hop needs to be multiple of 4 (e.g., 48 RB). In some implementations, the number of RB can be indicated as 4*(n−1)+24 (e.g., 24 RB at least, where n is an integer. e.g., n=7 for a total of 48 RB). In some implementations, the RBs of the first hop (of a RedCap UE) can be RB #0, 1, 2, . . . 47 (relative to CRB, or CRB0, 48 RB in total). The RBs of the second hop (of a RedCap UE) can be RB #47, 48, 49, . . . 94 (relative to CRB, or CRB0, with one overlapped RB on RB #47 over the previous hop). The RBs of the third hop (of a RedCap UE) can be RB #94, 95, 96, . . . 141 (relative to CRB, or CRB0, with one overlapped RB on RB #94 over the previous hop). The RBs of the fourth hop (of a RedCap UE) can be RB #141, 142, 143, . . . 188 (relative to CRB, or CRB0, with one overlapped RB on RB #141 over the previous hop). The RBs of the fifth hop (of a RedCap UE) can be RB #188, 189, 190, . . . 235 (relative to CRB, or CRB0, with one overlapped RB on RB #188 over the previous hop).

In some implementations, the RBs of the first hop (of a RedCap UE) can be RB #0, 1, 2, . . . 51 (relative to CRB, or CRB0, 52 RB in total). The RBs of the second hop (of a RedCap UE) can be RB #51, 52, 53, . . . 102 (relative to CRB, or CRB0, with one overlapped RB on RB #51 over the previous hop). The RBs of the third hop (of a RedCap UE) can be RB #102, 103, 104, . . . 153 (relative to CRB, or CRB0, with one overlapped RB on RB #102 over the previous hop). The RBs of the fourth hop (of a RedCap UE) can be RB #153, 154, 155, . . . 204 (relative to CRB, or CRB0, with one overlapped RB on RB #153 over the previous hop). The RBs of the fifth hop (of a RedCap UE) can be RB #204, 205, 206, . . . 255 (relative to CRB, or CRB0, with one overlapped RB on RB #204 over the previous hop).

In some implementations, a mixed number of RBs (i.e., different number of RBs) can be applied to different hops (e.g., 48 RBs for the first hop while 56 RBs for other hops). In some implementations, the RBs of the first hop (of a RedCap UE) can be RB #0, 1, 2, . . . 47 (relative to CRB, or CRB0, 48 RBs in total). The RBs of the second hop (of a RedCap UE) can be RB #47, 48, 49, . . . 102 (relative to CRB, or CRB0, with one overlapped RB on RB #47 over the previous hop, 56 RBs in total). The RBs of the third hop (of a RedCap UE) can be RB #102, 103, 104, . . . 157 (relative to CRB, or CRB0, with one overlapped RB on RB #102 over the previous hop, 56 RB in total). The RBs of the fourth hop (of a RedCap UE) can be RB #157, 158, 159, . . . 212 (relative to CRB, or CRB0, with one overlapped RB on RB #157 over the previous hop, 56 RB in total). The RBs of the fifth hop (of a RedCap UE) can be RB #212, 213, 214, . . . 267 (relative to CRB, or CRB0, with one overlapped RB on RB #212 over the previous hop, 56 RB in total).

In some implementations, a mixed number of RBs (i.e., different number of RBs) can be applied to different hops (e.g., 52 RBs for the first hop while 56 RBs for other hops). In some implementations, the RBs of the first hop (of a RedCap UE) can be RB #0, 1, 2, . . . 51 (relative to CRB, or CRB0, 52 RBs in total). The RBs of the second hop (of a RedCap UE) can be RB #51, 52, 53 . . . 106 (relative to CRB, or CRB0, with one overlapped RB on RB #51 over the previous hop, 56 RBs in total). The RBs of the third hop (of a RedCap UE) can be RB #106, 107, 108, . . . 161 (relative to CRB, or CRB0, with one overlapped RB on RB #106 over the previous hop, 56 RBs in total). The RBs of the fourth hop (of a RedCap UE) can be RB #161, 162, 163, . . . 216 (relative to CRB, or CRB0, with one overlapped RB on RB #161 over the previous hop, 56 RB in total). The RBs of the fifth hop (of a RedCap UE) can be RB #216, 217, 218, . . . 271 (relative to CRB, or CRB0, with one overlapped RB on RB #212 over the previous hop, 56 RB in total).

In some implementations, the number of overlapped RB can be zero, or one, or two, or three, or four, or a number configured by the network. In some implementations, the RBs of the first hop (of a RedCap UE) can be RB #0, 1, 2, . . . 51 (relative to CRB, or CRB0, 52 RBs in total). The RBs of the second hop (of a RedCap UE) can be RB #50, 51, 52, . . . 101 (relative to CRB, or CRB0, with one overlapped RB on RB #50 and RB #51 over the previous hop). The RBs of the third hop (of a RedCap UE) can be RB #101, 102, 103, . . . 152 (relative to CRB, or CRB0, with one overlapped RB on RB #101 and RB #102 over the previous hop). The RBs of the fourth hop (of a RedCap UE) can be RB #152, 153, 154, . . . 203 (relative to CRB, or CRB0, with one overlapped RB on RB #152 and RB #153 over the previous hop). The RBs of the fifth hop (of a RedCap UE) can be RB #203, 204, 205, . . . 254 (relative to CRB, or CRB0, with one overlapped RB on RB #203 and RB #204 over the previous hop).

For a case with SCS=60 kHz and 20 MHz bandwidth support of a RedCap UE, in some implementations, the RBs of the first hop (of a RedCap UE) can be RB #0, 1, 2, . . . 23 (relative to CRB, or CRB0, 24 RB in total). The RBs of the second hop (of a RedCap UE) can be RB #23, 24, 25, . . . 46 (relative to CRB, or CRB0, with one overlapped RB on RB #23 over the previous hop). The RBs of the third hop (of a RedCap UE) can be RB #46, 47, 48, . . . 69 (relative to CRB, or CRB0, with one overlapped RB on RB #46 over the previous hop). The RBs of the fourth hop (of a RedCap UE) can be RB #69, 70, 71, . . . 92 (relative to CRB, or CRB0, with one overlapped RB on RB #92 over the previous hop). The RBs of the fifth hop (of a RedCap UE) can be RB #92, 93, 94, . . . 115 (relative to CRB, or CRB0, with one overlapped RB on RB #92 over the previous hop).

For a case with 20 MHz bandwidth support of a RedCap UE, the maximum number of RB within a hop is 104, 48, 24 at the SCS of 15, 30, 60 kHz, respectively. Thus, floor (Number_of_RB_at_20 MHz/4)*4 where the Number_of_RB_at_20 MHz is number of RB at 20 MHz.

For SCS=15 kHz and 5 MHz bandwidth support of a RedCap UE, there will be

$$Number\_of \_RB \_at \_ 100 MHz \text{} / ( floor ( Number\_of \_RB \_at \_ 5 MHz / 4 ) * 4 - 1 ) = 2 *$$

$$Number\_of \_RB \_at \_ 50 MHz \text{} / ( floor ( Number\_of \_RB \_at \_ 5 MHz / 4 ) * 4 - 1 ) = 2 * 270 / ( 24 - 1 ) = 23$$

hops with 24 RB in each hop and one overlapped RB between two adjacent hops.

In some implementations, for SCS=15 kHz and 5 MHz bandwidth support of a RedCap UE, there will be Number_of_RB_at_100 MHz/(floor (Number_of_RB_at_5 MHz/4)*4−2)=2*

$$Number\_of \_RB \_at \_ 50 MHz \text{} / ( floor ( Number\_of \_RB \_at \_ 5 MHz / 4 ) * 4 - 2 ) = 2 * 270 / ( 24 - 2 ) = 24$$

hops with 24 RB in each hop and two overlapped RB between two adjacent hops.

In some implementations, there are 32 hops at most with SCS=15 kHz and 5 MHz bandwidth support of a RedCap UE. In some implementations, there are 24 hops at most with SCS=15 kHz and 5 MHz bandwidth support of a RedCap UE and, two overlapped RB between two adjacent hops.

For SCS=30 kHz and 5 MHz bandwidth support of a RedCap UE, there will be

$$Number\_of \_RB \_at \_ 100 MHz / ( ceil ( Number\_of \_RB \_at \_ 5 MHz / 4 ) * 4 - 1 ) = 273 / ( 12 - 1 ) = 24 hops$$

with 12 RB in each hop and one overlapped RB between two adjacent hops.

For SCS-60 kHz and 5 MHz bandwidth support of a RedCap UE, there is no support for this configuration.

For SCS=60 kHz and 10 MHz bandwidth support of a RedCap UE, there will be

$$Number\_of \_RB \_at \_ 100 MHz / ( ceil ( Number\_of \_RB \_at \_ 10 MHz / 4 ) * 4 - 1 ) = 135 / ( 12 - 1 ) = 12 hops$$

with 12 RB in each hop and one overlapped RB between two adjacent hops.

For SCS=60 kHz and 50 MHz bandwidth support of a RedCap UE (on, frequency range 2, FR2), there will be 2 hops with 64 RB for PRS/SRS in each hop and one overlapped RB (e.g., on RB #63) between two adjacent hops.

For SCS=120 kHz and 50 MHz bandwidth support of a RedCap UE (on, frequency range 2, FR2), there will be 2 hops with 32 RB for PRS/SRS in each hop and one overlapped RB (e.g., on RB #31) between two adjacent hops.

For SCS-60 KHz and 100 MHz bandwidth support of a RedCap UE (on, frequency range 2, FR2), there is no support for this configuration. In some implementations, there will be 2 hops with 132 RB in each hop and one overlapped RB (on RB #131) between two adjacent hops.

For SCS=120 kHz and 100 MHz bandwidth support of a RedCap UE (on, frequency range 2, FR2), there is no support for this configuration. In some implementations, there will be 2 hops with 64 RB in each hop and one overlapped RB (on RB #63) between two adjacent hops.

In some implementations, a hop can start from higher frequency to lower frequency. For example, for SCS-60 KHz and 50 MHz bandwidth support of a RedCap UE (on, frequency range 2, FR2), there will be 2 hops with 64 RB for PRS/SRS in each hop and one overlapped RB (e.g., on RB #63) between two adjacent hops. The first hop (of PRS/SRS) is on RB #63, 64, 65, . . . 126 (relative to CRB or CRB0) and, the second hop (of PRS/SRS) is on RB #0, 1, 2, . . . 63 (relative to CRB or CRB0). In some implementations, a hop can start from lower frequency (e.g., small RB index) to higher frequency (e.g., large RB index).

In some implementations, the BWP ID in a DCI can be hop ID (e.g., 0, 1, 2, 3).

In some implementations, a receiver (e.g., gNB) can receive each segment (or BWP, or hop), adjust a phase of each segment, and concatenate the segments together. After that, a receiver (e.g., gNB) can measure/report the positioning related results on the concatenated segments. For example, the receiver configures SRS for a UE. Then, the UE transmits SRS (e.g., two hops, i.e., two transmissions on different frequencies). When the receiver receives two hops of SRS at different times, the receiver concatenates two hops of SRS. Then, the receiver measures on the concatenated SRS.

In some implementations, for a side link positioning, a UE may not transmit the side link PRS/SRS (with hopping or not) even if it is requested by another UE (or the network, or an anchor UE, or a road side unit, RSU). In some implementations, a UE can stop transmitting of the side link PRS/SRS even if it indicates it has this capability of the transmission of the side link PRS/SRS. This can reduce the chance of explosion of the location of UE itself.

According to the implementations, the hopping of SRS/PRS can be enabled with the overlapping between hops (to adjust a coherent phase of channel). Hence, the effective bandwidth can be extended. As the result of that, the performance of positioning can be improved (e.g., a higher positioning accuracy).

### Implementation Example 2: Hopping Specific MG/PPW

For a PRS reception, at least one of a measurement gap (MG) or PRS processing window (PPW) can be configured for a RedCap UE. In the implementations, a hopping-specific MG/PPW (or referred to as a RedCap-specific MG/PPW) is configured for a PRS reception (or PRS transmission). Within this hopping-specific MG/PPW, only the hopped PRS can be received (or transmitted). The non-hopped PRS can only be received (or transmitted) in a normal MG/PPW.

In some implementations, the first hop of PRS hopping is outside of a MG/PPW (or a hopping-specific MG/PPW, or RedCap-specific MG/PPW) while the rest hop(s) of PRS hopping is/are inside of a MG/PPW (or a hopping-specific MG/PPW, or RedCap-specific MG/PPW). In some implementations, the time gap between the first hop of PRS hopping and the MG/PPW is a hopping gap (or radio frequency, RF, re-tuning time). In some implementations, the time gap between the first hop of PRS hopping and the MG/PPW is longer than the RF re-tuning time. In some implementations, the time gap between the first hop of PRS hopping and the MG/PPW is longer than the RF re-tuning time but shorter than double of the RF re-tuning time.

In some implementations, the minimum time duration of a MG/PPW (or a hopping-specific MG/PPW, or RedCap-specific MG/PPW) is (floor (BW_PRS/BW_UE)−1)*RF_Rc_tuning_Time, or (Hop_Number−1)*RF_Re_tuning_Time. In some implementations, the minimum time duration of a MG/PPW (or a hopping-specific MG/PPW, or RedCap-specific MG/PPW) is floor (BW_PRS/BW_UE)*RF_Re_tuning_Time, or Hop_Number*RF_Rc_tuning_Time. The BW_PRS is the bandwidth of PRS (e.g., in number of RB, e.g., 273RB@SCS=30 kHz of 100 MHz), the BW_UE is the maximum bandwidth supported by a RedCap UE (e.g., in number of RB, e.g., 51RB@SCS-30 kHz of 20 MHZ), the RF_Re_tuning_Time is the time duration when a RedCap UE switches from one frequency to another (or, from one virtual BWP to another, e.g., one time slot), the Hop_Number is the number of hops configured by higher layer. In some implementations, the minimum time duration of a MG/PPW (or a hopping-specific MG/PPW, or RedCap-specific MG/PPW) is floor (BW_PRS/BW_UE)*(RF_Re_tuning_Time+PRS_Duration), or Hop_Number*(RF_Re_tuning_Time+PRS_Duration) where the PRS_Duration is the duration of PRS transmission (or reception, or PRS measurement). In some implementations, the PRS_Duration can be Number_of_Symbol*Duration_of_Symbol where the Number_of_Symbol is the number of symbol configured for PRS transmission (e.g., two symbols), the Duration_of_Symbol is the duration of symbol (e.g., 35.7 μs@SCS=30 kHz).

In some implementations, for the hopped PRS, the minimum repetition period is a hopping gap (or RF re-tuning time). In some implementations, for the hopped PRS, the minimum repetition period is sum of a hopping gap (or RF re-tuning time) and the duration of PRS transmission (or reception).

In some implementations, for the hopped PRS, the minimum repetition is floor (BW_PRS/BW_UE) or Hop_Number.

In some implementations, for a MG (or a hopping-specific MG, or RedCap-specific MG), the PRS has the highest priority (i.e., the PRS prioritizes over all other DL signals/channels). In some implementations, for a MG (or a hopping-specific MG, or RedCap-specific MG), the PRS prioritizes over all other DL signals/channels except synchronization signal block (SSB).

In some implementations, for a PPW (or a hopping-specific PPW, or RedCap-specific PPW), the PRS has the highest priority (i.e., the PRS prioritizes over all other DL signals/channels). In some implementations, for a PPW (or a hopping-specific PPW, or RedCap-specific PPW), the PRS prioritizes over all other DL signals/channels except SSB. In some implementations, for a PPW (or a hopping-specific PPW, or RedCap-specific PPW), the PRS PRS prioritizes over all other DL signals/channels except SSB and physical downlink control channel (PDCCH) for ultra-reliable and low latency communication (URLLC). In some implementations, within a PPW (or a hopping-specific PPW, or RedCap-specific PPW), the overlapped PRS symbol(s) with SSB/PDCCH for URLLC is/are dropped. In some implementations, within a PPW (or a hopping-specific PPW, or RedCap-specific PPW), the overlapped time slot(s) with SSB/PDCCH for URLLC is/are dropped. In some implementations, within a PPW (or a hopping-specific PPW, or RedCap-specific PPW), the overlapped PRS hop(s) with SSB/PDCCH for URLLC is/are dropped.

In some implementations, both MG and PPW are configured for a RedCap UE. In some implementations, some hops of PRS (e.g., first two hops of five hops) are performed in MG while the other hops of PRS (e.g., last three hops of five hops) are performed in PPW. In some implementations, some hops of PRS are performed in MG while the other hops of PRS are performed in PPW if the PRS prioritized over all other DL signals/channels in a MG. With this method, the positioning performance is high enough while the priority of other signals/channels can be maintained (in PPW).

In some implementations, within a PPW, a RedCap UE can process one (virtual) carrier/positioning frequency layer (PFL). In some implementations, within a PPW, a RedCap UE can process one (virtual) carrier/PFL at one time.

In some implementations, for a UE supporting carrier/PFL aggregation, multiple PPWs can be configured (e.g., each carrier/PFL has a PPW. These PPWs can have the same start/end time or duration).

In some implementations, priority of PRS over other signal/channel within a PPW for each (virtual) carrier/PFL may be different. For example, the priority of PRS may be higher than other signals/channels in the PPW for the first carrier, while the priority of PRS may be lower than other signals/channels in the PPW for the second carrier. In this case, the final priority of PRS may be dependent on the highest priority of PRS in each PPW (for each carrier). In some implementations, the final priority of PRS may be dependent on the lowest priority of PRS in each PPW (e.g., the lowest priority will be applied). In some implementations, the final priority of PRS may be dependent on the priority of PRS in the PPW of the first (virtual) carrier/PFL/hop/BWP/sub-BWP. In some implementations, the final priority of PRS may be dependent on the priority of PRS in the PPW of the last (virtual) carrier/PFL/hop/BWP/sub-BWP. In some implementations, the final priority of PRS may be dependent on the priority of PRS in the PPW of the first transmission/reception of PRS. In some implementations, the final priority of PRS may be dependent on the priority of PRS in the PPW of the last transmission/reception of PRS.

In some implementations, for a UE supporting carrier/PFL aggregation (e.g., four PFL), multiple PPW can be configured (e.g., two PPW, each PPW is with two PFL). In some implementations, each PPW is with a carrier/PFL list that this UE can process at one time.

In some implementations, for a UE supporting carrier/PFL aggregation (e.g., five carriers), only one PPW is configured where this PPW is with a carrier/PFL list that this UE can process at one time. In some implementations, this carrier/PFL list is with carrier ID (or cell ID).

In some implementations, a UE may report its PPW capability to the network.

In some implementations, the configuration of PRS of a UE can be shared by other UE (even a UE in another cell, or a UE under inactive/idle state).

In some implementations, during a MG (or a hopping-specific MG, or RedCap-specific MG), there is one or multiple active (virtual) BWP switching (or sub-BWP switching) for PRS reception. In some implementations, the active (virtual) BWP switching (or sub-BWP switching) is for processing different hops of PRS.

In some implementations, multiple (concurrent) MG can be configured for a UE. In some implementations, multiple (concurrent) MG can be configured for a UE with multiple carrier/PFL. In some implementations, each carrier/PFL can be associated with one specific MG. In some implementations, one carrier/PFL can be associated with one different MG from another MG for a carrier/PFL.

In some implementations, during a PPW (or a hopping-specific PPW, or RedCap-specific PPW), there is one or multiple active BWP switching for PRS reception. In some implementations, the active (virtual) BWP switching (or sub-BWP switching) is for processing different hops of PRS within a PPW.

In this implementation, with a hopping-specific MG/PPW (or RedCap-specific MG/PPW), the DL signal/channel can be processed with priority while the performance of positioning can be improved over a non-hopped case (e.g., a higher positioning accuracy).

### Implementation Example 3: Component Carrier Level SRS

Currently, the SRS is configured under BWP. The SRS on a current active BWP can be transmitted while the SRS on an inactive BWP cannot be transmitted.

In some implementations, the SRS can be configured under a carrier (equivalently, a cell, or a serving cell). In some implementations, the configuration of SRS on a carrier (component carrier, CC, CC level SRS) includes frequency information (e.g., Absolute Radio Frequency Channel Number, ARFCN, start/end frequency in RB which is relative to CRB/CRB0, bandwidth in number of RB). It should be noted that the carrier can be a virtual carrier (e.g., its bandwidth can be larger than a physical carrier with which it associates).

In some implementations, if the CC level SRS is configured, a UE needs to apply the CC level SRS (e.g., transmitting CC level SRS). In some implementations, if the CC level SRS is configured, a UE needs to apply the CC level SRS (e.g., transmitting CC level SRS) instead of applying the BWP level SRS (i.e., SRS configured under BWP). Thus, if the CC level SRS is configured, a UE transmits the CC level SRS without transmitting the BWP level SRS). In some implementations, if the CC level SRS is configured, a UE needs to apply the CC level SRS (e.g., transmitting CC level SRS) instead of applying the BWP level SRS even if the BWP level SRS is configured.

In some implementations, the SRS sequence generator for SRS sequence of SRS transmission needs to be initialized with a carrier ID (or, serving cell index, or a value related to serving cell, or a value configured by higher layer).

For the CC level SRS, a BWP (or virtual BWP) with identical bandwidth to that of the CC (or virtual carrier) it belongs to is configured. In some implementations, a virtual BWP can have larger bandwidth than a physical BWP. In some implementations, a virtual BWP can have larger bandwidth than a physical BWP with which it associates. In some implementations, the bandwidth of the SRS configured on a BWP (or virtual BWP) can be wider than that of the BWP.

A RedCap UE can be configured with one SRS resource which can be distributed on several BWPs (or virtual BWPs), which include, for example, Hop_Number virtual BWP, a physical BWP, and Hop_Number−1 virtual BWP). In some implementations, a list of start/end frequency (e.g., RB index) and bandwidth (e.g., number of RB) of SRS resource will be configured for each BWP (or virtual BWP). In some implementations, a list of start/end frequency (e.g., RB index, e.g., ARFCN) and bandwidth (e.g., number of RB) of SRS resource will be configured for a carrier (or virtual carrier). With BWP switching (or virtual BWP switching), a RedCap UE can hop a segment of SRS (or SRS bandwidth) to another.

In some implementations, with carrier switching (or virtual carrier switching), a RedCap UE can hop a segment of SRS (or SRS bandwidth) to another.

In some implementations, a RedCap UE can be configured with multiple SRS resources (e.g., Hop_Number SRS resources) and each SRS resource is associated with a corresponding BWP (or virtual BWP). With BWP switching (or virtual BWP switching), a RedCap UE can hop from one SRS resource to another to cover a large bandwidth.

According to the implementation, a CC level SRS can extend the bandwidth of SRS with hopping. Hence, the effective bandwidth can be extended. As the result of that, the performance of positioning can be improved (e.g., a higher positioning accuracy).

### Implementation Example 4: More than Four Hops with BWP Switching

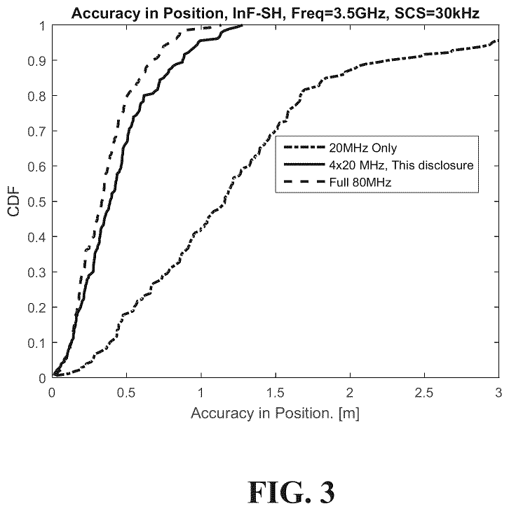

Currently, (at most) four BWP can be dynamically switched by a DCI (carried on a PDCCH, i.e., 0, 1, 2 bits for target BWP index). If the PRS/SRS hopping is based on BWP switching (i.e., there is one PRS/SRS hop on each BWP or virtual BWP), then there are four hops at most. These four hops can be triggered by DCI, or MAC CE, or pre-configuration. FIG. 3 illustrates a graph indicating an accuracy in position for UEs supporting hopping technology with frequency overlapping. As shown in FIG. 3, for a RedCap UE supporting 20 MHz bandwidth, four hops (4×20 MHz in total, 20 MHz for each hop) are enough to fulfil the requirement of industry internet of thing (IIOT) scenario (i.e., one meter@CDF=90% requirement) under indoor factory sparse high (InF-SH). In some cases, however, four hops are not enough (e.g., for a RedCap UE supporting 5 MHz or 10 MHz bandwidth) and more than four hops are required.

To support more than four hops (e.g., 24 hops in the previous example, for a RedCap UE supporting 5 MHz bandwidth), more bits are required in DCI for the BWP indication on the BWP switching (e.g., there are five bits for 32 hops, or 32 BWP, or 32 virtual BWP). In some implementations, a DCI with multiple indication bits (e.g., 32 bits) can indicate one or more hops of PRS/SRS (e.g., a bitmap or a codepoint is applied).

In some implementations, a MAC CE with multiple indication bits (e.g., in addition to logical channel ID, one or more octets, e.g., 4 octets, one octet has 8 bits) can indicate one or more hops of PRS/SRS (e.g., with a bitmap or a codepoint, e.g., 32 hops).

In some implementations, a BWP can have several sub-BWPs (or virtual sub-BWPs). In the example, 0-8 sub-BWPs (or virtual sub-BWPs) can be configured by higher layer. In some implementations, one or more sub-BWP (or virtual sub-BWP) can be associated with a BWP. In some implementations, the bandwidth of a sub-BWP (or virtual sub-BWP) can be out of the range of the BWP with which it associates. In some implementations, the bandwidth of a sub-BWP (or virtual sub-BWP) except one sub-BWP (or, virtual sub-BWP, e.g., the first sub-BWP, e.g., the sub-BWP with ID=0) can be out of the range of the BWP with which it associates. In some implementations, a RedCap UE switches sub-BWP in order of sub-BWP ID. In some implementations, a RedCap UE switches sub-BWP in order of sub-BWP ID after receiving a PRS/SRS hopping indication or a sub-BWP switching indication. With this implementation, a RedCap UE switches BWP first, then switches sub-BWP that is associated with a same BWP. In some implementations, the BWP switching can be indicated by DCI/MAC CE while the sub-BWP switching can be automatic (e.g., based on sub-BWP ID, from low index to high index, after receiving an indication of BWP switching for the BWP with which it associates).

In some implementations, the first sub-BWP (or, virtual sub-BWP, or, virtual BWP, e.g., with an ID=0) is mapped on a physical BWP. In some implementations, the first sub-BWP (or, virtual sub-BWP) is for the first hop (e.g., with hop ID=0).

In some implementations, one sub-BWP (or virtual sub-BWP) is configured with a PRS/SRS resource. After receiving/transmitting PRS/SRS in each BWP/Sub-BWP (e.g., 2 with BWP/sub-BWP switching, a UE can cover a large bandwidth (e.g., 5 hops/BWP/sub-BWP for a 100 MHz bandwidth). Hence, the positioning accuracy can be improved.

In some implementations, the sub-BWP ID (or virtual sub-BWP ID, or BWP ID, or virtual BWP ID) is equal to the PRS/SRS resource ID.

In some implementations, one PRS/SRS resource is configured for all sub-BWP (or virtual sub-BWP, or BWP, or virtual BWP). Each sub-BWP (or virtual sub-BWP, or BWP, or virtual BWP) contains one segment of this PRS/SRS resource (e.g., equal segmentation between hops, e.g., a hop is with a segment).

In some implementations, a sub-BWP (or virtual sub-BWP, or BWP, or virtual BWP) is with a frequency start point (e.g., RB ID relative to CRB/CRB0, an ARFCN), length/number of RB (or frequency range or end point of frequency (e.g., RB ID relative to CRB/CRB0, an ARFCN).

In some implementations, for PRS/SRS transmission on each sub-BWP (or virtual sub-BWP, or BWP, or virtual BWP), an identical transmission power is applied. In some implementations, for PRS/SRS transmission on a sub-BWP (or virtual sub-BWP, or BWP, or virtual BWP, or a hop), an identical transmission power spectrum density (PSD, power divided by bandwidth) is applied.

In some implementations, for PRS/SRS transmission on each sub-BWP (or virtual sub-BWP, or BWP, or virtual BWP, or hop), an identical SCS is applied.

In some implementations, for PRS transmission on a sub-BWP (or virtual sub-BWP, or BWP, or virtual BWP, or a hop), a PRS-specific sub-BWP (or virtual sub-BWP, or BWP, or virtual BWP, or a hop) is applied. In some implementations, for a PRS-specific sub-BWP, there is no data channel, no PDCCH, no other reference signal. In some implementations, for a PRS-specific sub-BWP, there is no data channel, no PDCCH, no other reference signal except SSB.

In some implementations, for SRS transmission on a sub-BWP (or virtual sub-BWP, or BWP, or virtual BWP, or a hop), a SRS-specific sub-BWP (or virtual sub-BWP, or BWP, or virtual BWP, or a hop) is applied. In some implementations, for a SRS-specific sub-BWP, there is no data channel, no physical uplink control channel (PUCCH), no physical random access channel (PRACH), no other reference signal. In some implementations, for a SRS-specific sub-BWP, there is no data channel, no PUCCH, no other reference signal except PRACH.

In some implementations, one or more BWPs (or one or more virtual BWPs, a virtual BWP can be a BWP outside of a carrier/cell, e.g., a BWP outside of a 20 MHz carrier) can be grouped into a BWP group (e.g., a BWP group has 1-8 BWP) with group ID (e.g., 0-3 for four BWP groups). With this implementation, first, a BWP group switching will be performed (e.g., based on DCI/MAC CE indication). Then, a BWP switching within a BWP group will be performed (e.g., automatically, based on BWP ID).

In some implementations, if there are less than or equal to 4 hops, then only BWP switching is performed. In this case, no BWP group switching or only one BWP group switching is performed. In some implementations, if there are more than 4 hops, then both BWP group switching and BWP switching are performed.

In some implementations, the first BWP group (e.g., group ID=0) contains a physical BWP (e.g., with BWP ID=0).

According to the implementations, the hopping of SRS/PRS can be enabled with (sub-) BWP switching (virtual BWP switching) between hops. Hence, the effective bandwidth can be extended. As the result of that, the performance of positioning can be improved (e.g., a higher positioning accuracy).

### Implementation Example 5: Partial Transmission-Based Positioning

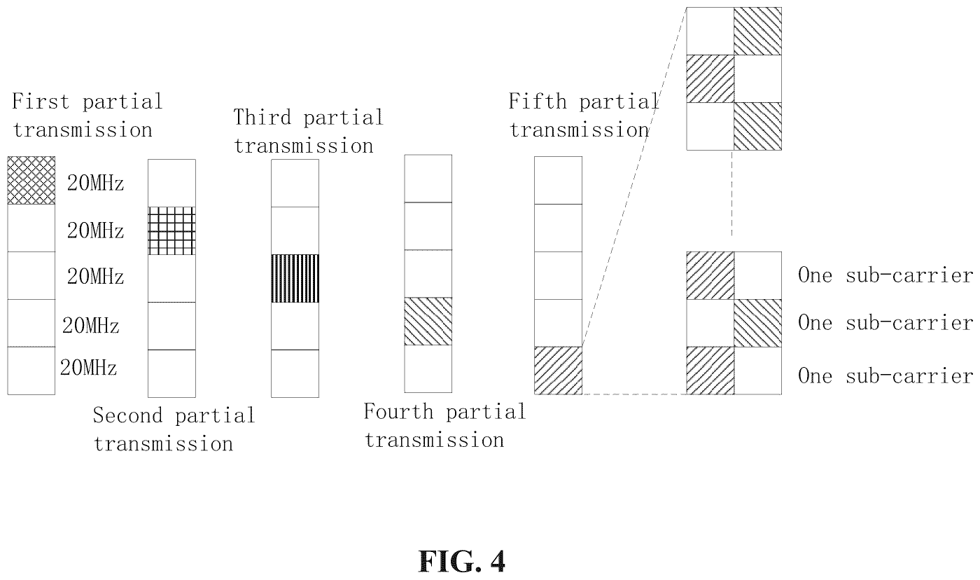

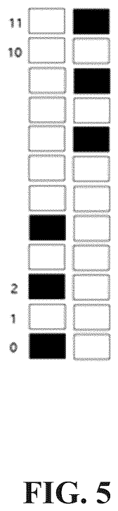

The SRS can be configured with a partial transmission (partial sounding) on a BWP (or a virtual BWP, or a carrier, or a virtual carrier) as shown in FIG. 4. FIG. 4 illustrates an example of SRS transmissions including first to fifth partial transmissions. In FIG. 4, a block with a hatch pattern will be transmitted while a block without any hatch patterns will not be transmitted. In FIG. 4, each partial transmission has a hatched pattern which indicates a hop of 20 MHz. In FIG. 5, the block structure of the fifth partial transmission is shown as an example. First to fourth partial transmissions have a same block structure as that for the fifth partial transmission, although each transmission has different frequencies.

For this partial transmission-based positioning, a higher layer (or gNB) will configure a (virtual) BWP (or a carrier, or virtual carrier) with a relatively large bandwidth (e.g., 100 MHZ, or 273 RB@SCS-30 kHz) for a RedCap UE. For this relatively large bandwidth, a UE will transmit only one part of it (e.g., the first transmission is on the lowest frequency with 20 MHZ bandwidth, or 48 RB@SCS=30 kHz. e.g., the second transmission is on the second lowest frequency with 20 MHz bandwidth and one or more overlapped RB).

In some implementations, for this partial transmission-based positioning, the transmission number (i.e., ID) is associated with a symbol ID or a slot number or a system frame number. For example, the first partial transmission takes place at SFN mod SRS_Period=0 with the slot number being zero and the symbol ID being the first configured symbol (e.g., 12). In the example, the SFN is system frame number (0 to 1023), the SRS_Period is SRS period (e.g., 10 ms).

In some implementations, for this partial transmission-based positioning, the Comb size is one (all the sub-carrier in a RB). In some implementations, for this partial transmission-based positioning, the Comb size can be configured as one only.

In some implementations, for this partial transmission-based positioning, there is an extended bandwidth indication for the SRS resource. The SRS resource may be outside of current active BWP (or carrier). In some implementations, the bandwidth of reference signal for positioning can be outside of the current active (virtual) BWP (or sub-BWP). In some implementations, the reference signal for positioning can span outside of the current active (virtual) BWP (or sub-BWP).

In some implementations, for this partial transmission-based positioning, the partial transmission factor (PTF) can be configured. For example, the PTF can be configured as a transmission bandwidth in a time divided by total transmission bandwidth, e.g., 20 MHz/100 MHz=1/5, where the total transmission bandwidth is the summary of all the transmission bandwidth in a time. The PTF can be configured as other values without not being limited to the transmission bandwidth in a time divided by the total transmission bandwidth. In some other implementations, if the partial transmission factor (PTF) is not configured, then the partial transmission factor will be set as, for example, a transmission bandwidth in a time divided by total bandwidth.

In some implementations, for this partial transmission-based positioning, the starting RB of partial transmission can be configured. For example, the starting RB of the first transmission (Starting_RB_First) of the partial transmission is configured as zero. According to this configuration, the starting RB of the second/third/fourth/fifth transmission (Starting_RB_Second) of the partial transmission is Starting_RB_First+PTF*Total_Bandwidth*(Transmission_ID−1)+Overlap_RB. In the example, the Total_Bandwidth is total bandwidth for partial transmission-based SRS, Transmission_ID is the transmission ID for each partial transmission (e.g., 2/3/4/5 for the second/third/fourth/fifth transmission). If it is not configured, then the starting RB of the first transmission of partial transmission will be zero.

In some implementations, for this partial transmission-based positioning, there is a sequence ID (e.g., 0-65535) that is used to generate sequence for SRS.

In some implementations, for this partial transmission-based positioning, the spatial relationship (e.g., quasi-colocation, QCL) with other signals can be configured (e.g., QCL-Type-C or QCL-Type-D). For example, the first transmission of this partial transmission can have a spatial relationship with SSB (including cell defining SSB, CD-SSB, non-cell defining SSB, NCD-SSB), channel state information reference signal (CSI-RS). For example, the remaining transmission (e.g., second/third/four/fifth transmission) of this partial transmission can have a spatial relationship with the first transmission of SRS in this partial transmission.

In some implementations, if an initial downlink BWP for all UEs and an initial downlink BWP for RedCap UE are configured, then the QCL source can be the SSB on the initial downlink BWP for RedCap UE.

In some implementations, for this partial transmission-based positioning, one SRS resource can be configured (with large bandwidth, e.g., 100 MHz). In some implementations, for this partial transmission-based positioning, Number_of_Transmission SRS resources can be configured (with small bandwidth, e.g., 20 MHz). In the example, the Number_of_Transmission is the total number of transmissions with a relatively small bandwidth. In some implementations, for this partial transmission-based positioning, 1/PTF SRS resources can be configured (with the relatively small bandwidth, e.g., 20 MHz). In some implementations, for this partial transmission-based positioning, floor (1/PTF) SRS resources can be configured (with the relatively small bandwidth, e.g., 20 MHz).

In some implementations, the SRS resource for this partial transmission-based positioning is a semi-period resource (e.g., a resource can be activated by a MAC CE) or an aperiod resource (e.g., a resource can be activated by a DCI).

In some implementations, the Comb size can be greater than the number of symbols allocated (e.g., Comb=4, Symbol=2) as shown in FIG. 5. FIG. 5 illustrates an example of two allocated symbols. In FIG. 5, since there are 12 resource elements (REs) within a resource block, the Comb size is obtained by dividing 12 by the number of transmitted REs within a symbol. In FIG. 5, there are three shaded blocks indicating three transmitted REs and thus the Comb size is 4. In a RB, the first/third/fifth sub-carrier (see the shaded boxes in FIG. 5) on the first symbol (left column in FIG. 5) and the eighth/tenth/twelfth sub-carrier (see the shaded boxes in FIG. 5) on the second symbol (right column in FIG. 5) are allocated to a RedCap UE.

In some implementations, a UE may report its capability on this partial transmission-based positioning. For example, the capability on the transmission bandwidth in a time, the capability on the total bandwidth, and/or the capability on PTF may be reported.

According to the implementation, a relatively large bandwidth of SRS/PRS can be enabled with overlapping between different parts of partial transmission (to adjust a coherent phase of channel). Hence, the effective bandwidth can be extended, which improves the performance of positioning (e.g., a higher positioning accuracy).

### Implementation Example 6: PRS/SRS Transmission/Reception Based on Carrier Switching

A RedCap UE can be configured with multiple carriers (or virtual carriers) which can overlap on frequency with some resources (e.g., one RB) between two neighbouring carriers. In the implementations, the carriers include virtual carriers as well. The PRS/SRS transmission/reception can be based on carrier switching.

In some implementations, each (virtual) carrier is configured with a carrier ID (or serving cell ID, or hop ID, e.g., 0, 1, 2, . . . 30, 31, 32, . . . 63). A DCI/MAC CE/higher layer signaling can indicate one or more (virtual) carriers being triggered. After receiving a DCI/MAC CE/higher layer signaling, a RedCap UE can switch from one (virtual) carrier to another. If the switch is triggered by a DCI, 0-5 bits (or 0-32 bits) can be configured for the indication. In some implementations, there is one bit differential between the normal UE and the RedCap UE. In some implementations, a (virtual) carrier switching order list is configured to indicate the carrier switching sequence (e.g., 0, 1, 2, 3, 4 of carrier ID). In some implementations, the (virtual) carrier with the first carrier ID in the list will be for the first transmission/reception (or first hop, or reference transmission/reception, or reference hop, or reference carrier, or reference resource).

In some implementations, a UE should report its capability on carrier switching (e.g., RF re-tuning time between two carriers, number of carrier/virtual carrier it supports).

In some implementations, there is a sequence ID (e.g., 0-8191) that is used to generate a sequence for PRS/SRS and each (virtual) carrier has one sequence ID.

In some implementations, a special slot with flexible symbol or uplink symbol is configured for (virtual) carrier switching. In some implementations, there is no other signal/channel on this special slot except PRS/SRS. In some implementations, if there is other signal/channel on this special slot, PRS/SRS has high priority over other signal/channel. In some implementations, there is a priority list for PRS/SRS and other signal/channel.

In some implementations, the (virtual) carrier transmission/reception order is (virtual) carrier ID (or hop ID, or sequence ID above).

In some implementations, the generation of sequence for PRS/SRS is associated with previous (virtual) carrier/hop.

According to the implementation, the hopping of SRS/PRS can be enabled with overlapping between (virtual) carriers/hops (to adjust a coherent phase of channel). Hence, the effective bandwidth can be extended, which improves the performance of positioning (e.g., a higher positioning accuracy).

### Implementation Example 7 (Antenna Switching Based Solution)

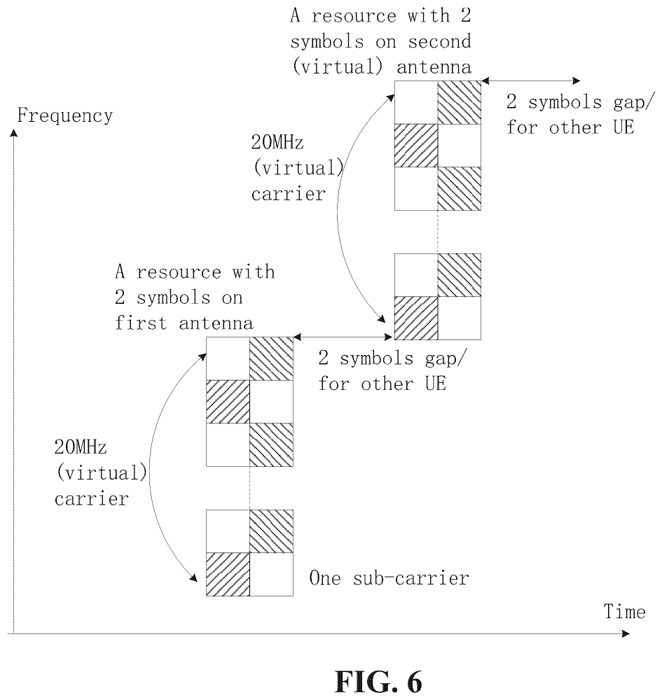

For a RedCap UE on FR1, it may have a single physical antenna. For this kind of UE, it can be configured with one or more virtual antennas where a virtual antenna is actually mapped to the same physical antenna. In some implementations, both the physical antenna and the virtual antenna have antenna IDs (or, antenna port IDs). In some implementations, each antenna (or, antenna ID) is associated with a (virtual) carrier (or cell, e.g., 20 MHz) or a segment of a (virtual) carrier (or cell) as shown in FIG. 6. Referring to FIG. 6, the first antenna and the second (virtual) antenna are configured for a UE. The first antenna for transmitting a resource with 2 symbols is associated with a 20 MHz carrier. The second (virtual) antenna for transmitting a resource with 2 symbols is associated with another 20 MHz carrier.

In some implementations, there is a frequency overlap (e.g., one RB) between two contiguous transmissions of two (virtual) carriers or two segments of a (virtual) carrier.

In some implementations, there is a time gap between two contiguous transmissions of two virtual antennas. In some implementations, a UE may report this time gap as its capability. It should be noted that, during this time gap, another UE can have transmission of SRS/PRS.

In some implementations, a DCI/MAC CE/higher layer signaling can indicate one or more (virtual) antennas being triggered. In some implementations, a DCI/MAC CE/higher layer signaling can indicate the transmission order of (virtual) antennas.

For a RedCap UE on FR2, it may have two physical antennas. In this case, zero or more virtual antennas can be configured to utilize the solution above.

In some implementations, the (virtual) antenna ID of transmitting (virtual) antenna is associated with a slot number, e.g., ID=Slot_Number mod Number_of_Virtual_Antenna. In the example, the Slot_Number is a slot number (0, 1, 2, . . . 9) in a radio frame (10 ms), and the Number_of_Virtual_Antenna is the total number of virtual antennas (e.g., 5).

In some implementations, one PRS/SRS resource is mapped onto a virtual antenna where one PRS/SRS resource is associated with the transmission order (e.g., in order of virtual antenna ID, carrier ID). The transmission order indicates an order according to which the transmissions proceed. In one example, the transmission order can be indicated by a sequence of antenna IDs such that a transmission with least antenna ID can happen first. In another example, the transmission order can be indicated by a sequence of carrier IDs such that a transmission with least carrier ID can happen first. Such transmission orders are examples only and other implementations are also possible. In some implementations, the transmission order is indicated in system information broadcast (SIB). In some implementations, there is only one PRS/SRS resource with several segments (on different frequency with overlapping), one segment is mapped onto a virtual antenna.

According to the implementation, the hopping of SRS/PRS can be enabled with the overlapping between hops (to adjust a coherent phase of channel) with virtual antenna switching. Hence, the effective bandwidth can be extended, which can improve the performance of positioning (e.g., a higher positioning accuracy).

### Implementation Example 8: Improving Channel Estimation on Overlapped RB/RE/SC

The positioning performance of PRS/SRS hopping highly relies on a channel estimation on the overlapped resource block (RB)/resource element (RE)/sub-carrier (SC). It is necessary to research how to improve channel estimation on it.

A power boosting is applied on the overlapped RB/RE/SC. For example, relative to other non-overlapped RB/RE, 3 dB more power is applied.

In some implementations, a gNB/UE computes path loss (PL) of SRS/PRS. A gNB indicates the number of overlapped RB/RE/SC according to PL. In some implementations, the network can increase the number of overlapped RB/RE/SC.

In some implementations, if the reference signal received power (RSRP) is lower than a threshold, a gNB/UE can select one path that is before a path with the highest RSRP where a gNB/UE uses the selected path for channel estimation/phase estimation.

In some implementations, a gNB/UE can provide line of sight (LOS)/non-LOS (NLOS) probability to the network.

According to the implementation, the channel estimation on the overlapped RB/RE/SC can be improved and the performance of positioning can be improved (e.g., a higher positioning accuracy).

### Implementation Example 9: Drop of SRS Transmission for Power Saving

If a UE detects its location without any changes relative to last positioning, a UE can drop the SRS transmission for power saving. For example, the UE can have an inner sensor and detect its location. A gNB can detect the energy on SRS symbol(s) to check whether a UE transmit SRS or not. If the detected energy is lower than a threshold, a gNB can declare “without detection” and, send this declaration to the network.

In some implementations, when the battery of UE is lower than a threshold, a UE can drop the SRS transmission for power saving.

In some implementations, a UE can transmit PRACH/PUCCH/PUSCH (e.g., single symbol) to indicate the drop of the SRS transmission.

According to the implementation, it is possible to save the power without affecting the performance of positioning.

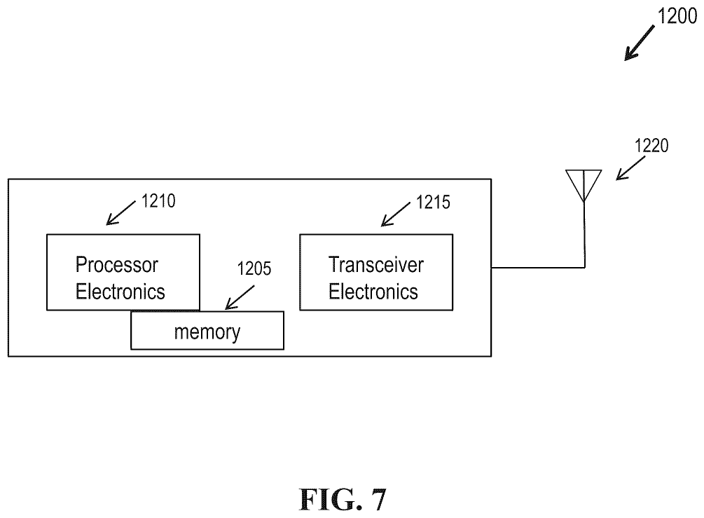

FIG. 7 is a block diagram of an example implementation of a wireless communication apparatus 1200. The methods described herein may be implemented by the apparatus 1200. In some embodiments, the apparatus 1200 may be a base station or a network device of a wireless network. In some embodiments, the apparatus 1200 may be a user device (e.g., a wireless device or a user equipment UE). The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in the figure, may be wired (e.g., fiber or Ethernet) or wireless.

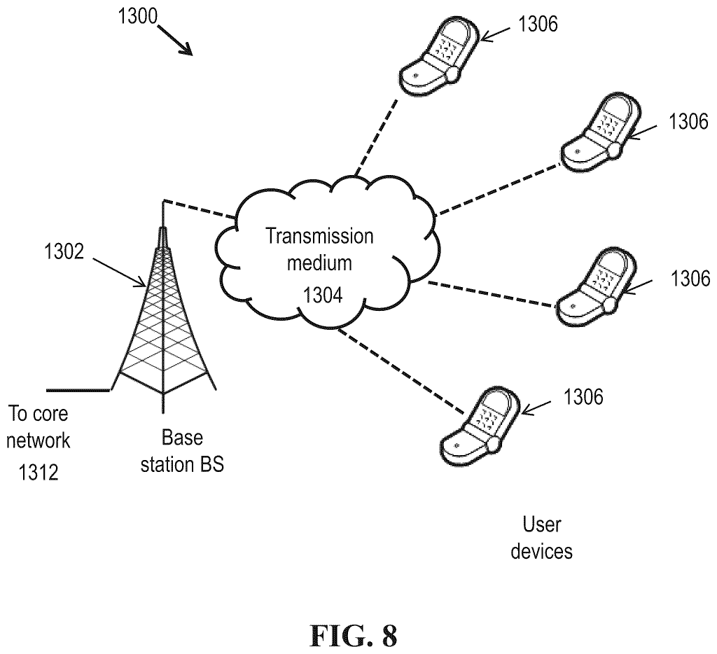

FIG. 8 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IoT) devices, and so on.

Some preferred embodiments may include the following solutions.

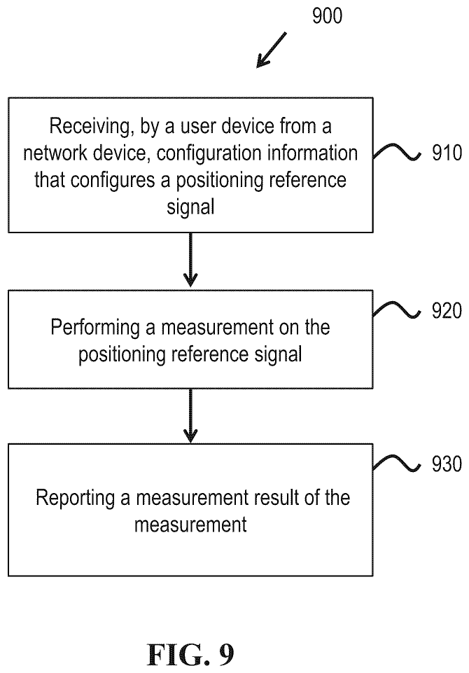

1. A method of wireless communication (e.g., method 900 as shown in FIG. 9), comprising: receiving 910, by a user device from a network device, configuration 920 information that configures a positioning reference signal; performing 930 a measurement on the positioning reference signal; and reporting a measurement result of the measurement.

2. The method of solution 1, wherein the configuration information includes one downlink control information that triggers a transmission or a reception of the positioning reference signal with hopping between two segments of the positioning reference signal that have different frequency ranges.

3. The method of solution 1, wherein the configuration information includes a medium access control (MAC) control element (CE) that indicates a transmission or a reception of the positioning reference signal.

4. The method of solution 1, wherein the configuration information configures a transmission window for a transmission of the positioning reference signal with hopping.

5. The method of solution 1, wherein the configuration information configures one positioning reference signal processing window (PPW) with a carrier list associated with a cell ID.

6. The method of solution 1, wherein the configuration information configures a measurement gap, a RedCap-specific MG, and for the RedCap-specific MG, the positioning reference signal prioritizes over other downlink signals and channels for the RedCap-specific MG.

7. The method of solution 1, wherein the configuration information configures a processing window for the positioning reference signal, a RedCap-specific PPW, and for the RedCap-specific PPW, the positioning reference signal prioritizes over all other downlink signals and channels except synchronization signal block.

8. The method of solution 1, wherein the configuration information configures multiple processing windows for positioning frequency layers, and for the multiple processing windows with different priorities applied to the positioning reference signal, a final priority is dependent on the lowest priority among the different priorities of the multiple processing windows.

9. The method of solution 1, wherein the configuration information configures multiple processing windows for positioning frequency layers, and for the multiple processing windows with different priorities applied to the positioning reference signal, a final priority is dependent on a priority of the PRS firstly transmitted in the multiple processing windows.

10. The method of solution 1, further comprising: applying, by the user device, a component carrier level SRS (sounding reference signal) instead of a BWP (bandwidth part) level SRS, in case that the component carrier level SRS is configured.

11. The method of solution 10, wherein a SRS sequence generator for generating a SRS sequence of the component carrier level SRS is initialized with a carrier ID.

12. The method of solution 10, wherein the configuration information configures multiple SRS resources and each SRS resource is associated with a corresponding BWP.

13. The method of solution 1, wherein the configuration information triggers a BWP group switching for a BWP group including one or more BWPs, the BWP group switching followed by a BWP switching for one of the one or more BWPs within the BWP group.

14. The method of solution 1, wherein the configuration information triggers a BWP group switching for a BWP group including one or more BWPs, the BWP group switching followed by a sub-BWP switching for a sub-BWP of one BWP of the one or more BWPs.

15. The method of solution 1, wherein the configuration information configures a partial transmission factor (PTF) that is a transmission bandwidth in a time divided by total transmission bandwidth.

16. The method of solution 15, further comprising: reporting, by the user device, a capability on the partial transmission factor (PTF) that is a transmission bandwidth in a time divided by total transmission bandwidth.

17. The method of solution 15, wherein the configuration information configures a spatial relationship of a first partial transmission with a synchronization signal block.

18. The method of solution 1, wherein the configuration information configures a carrier list indicating a carrier switching sequence such that a carrier with a first carrier ID in the list is for a first transmission or reception of the positioning reference signal.

19. The method of solution 1, wherein the configuration information includes a system information broadcast (SIB) indicating a transmission order of antennas with antenna IDs and a reference signal resource association.

20. The method of solution 1, wherein the configuration information indicates a number of overlapped resource blocks, resource elements, or sub-carriers.

21. The method of solution 1, further comprising concatenating multiple segments of the reference signal to obtain a concatenated reference signal, wherein the performing the measurement includes performing positioning related measurement on the concatenated reference signal.

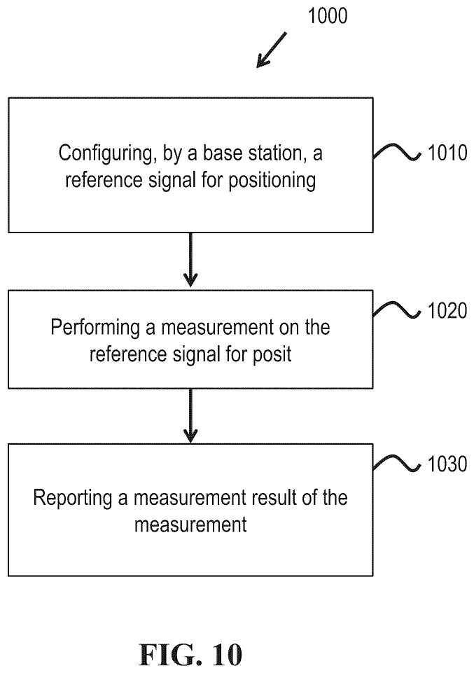

22. A method of wireless communication (e.g., method 1000 as shown in FIG. 10), comprising: configuring 1010, by a base station, a reference signal for positioning; performing 1020 a measurement on the reference signal for positioning; and reporting 1030 a measurement result of the measurement.

23. The method of solution 22, further comprising: receiving, from a user device, multiple segments of the reference signal with different frequency ranges; and concatenating the multiple segments of the reference signal to obtain a concatenated reference signal, wherein the measurement result includes a positioning related measurement on the concatenated reference signal.

24. A wireless communication apparatus comprising a processor configured to implement a method recited in any of above solutions.

25. A computer storage medium having code stored thereupon, the code, upon execution by a processor, causing the processor to implement a method recited in any of above solutions.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
receiving, by a user device from a first network device, a first configuration information that configures a frequency hopping of a sounding reference signal (SRS) for positioning,
wherein the first configuration information configures a periodicity and a duration of a transmission window for transmitting the sounding reference signal; and
transmitting, by the user device, the SRS for positioning according to the frequency hopping.

2. The method of claim 1, further comprising: applying, by the user device, a component carrier level SRS instead of a bandwidth part (BWP) level SRS.

3. The method of claim 1, wherein the first configuration information indicates a number of overlapping resource blocks.

4. The method of claim 3, wherein the number of overlapping resource blocks is between subsequent hops of the frequency hopping.

5. The method of claim 1, further comprising:
receiving, by the user device from a second network device, a second configuration information that configures a reception of a positioning reference signal (PRS);
receiving, by the user device from the first network device, the PRS; and
reporting, by the user device to the second network device, a measurement based on the PRS, wherein the PRS is associated with multiple hops, and wherein the measurement is performed based on the multiple hops.

6. The method of claim 5, wherein the user device is a reduced capability user equipment, and wherein the multiple hops form a bandwidth that is greater than a maximum bandwidth of the reduced capability user equipment.

7. The method of claim 1, wherein the frequency hopping is configured in one SRS resource, wherein the user device is configured to perform SRS frequency hopping with the one SRS resource on a bandwidth that is extended.

8. The method of claim 1, wherein the first configuration information includes a starting resource block of the SRS and a bandwidth of an SRS resource.

9. The method of claim 1, wherein the first configuration information configures an SRS resource, and wherein the SRS resource is outside a currently active BWP.

10. The method of claim 9, wherein an identical subcarrier spacing (SCS) is applied for hops within the SRS resource.

11. An apparatus for wireless communication comprising one or more processors and a memory storing instructions, execution of which by the one or more processors causes the apparatus to:
receive, from a first network device, a first configuration information that configures a frequency hopping of a sounding reference signal (SRS) for positioning,
wherein the first configuration information configures a periodicity and a duration of a transmission window for transmitting the sounding reference signal; and
transmit the SRS for positioning according to the frequency hopping.

12. The apparatus of claim 11, further caused to:
apply a component carrier level SRS instead of a bandwidth part (BWP) level SRS.

13. The apparatus of claim 11, wherein the first configuration information indicates a number of overlapping resource blocks between subsequent hops of the frequency hopping.

14. The apparatus of claim 13, wherein the number of overlapping resource blocks is between subsequent hops of the frequency hopping.

15. The apparatus of claim 11, further caused to:
receive, from a second network device, a second configuration information that configures a reception of a positioning reference signal, PRS;
receive, from the first network device, the PRS; and
report, to the second network device, a measurement based on the PRS, wherein the PRS is associated with multiple hops, and wherein the measurement is performed based on the multiple hops.

16. The apparatus of claim 15, wherein the apparatus is a reduced capability user equipment, and wherein the multiple hops form a bandwidth that is greater than a maximum bandwidth of the reduced capability user equipment.

17. The apparatus of claim 11, wherein the frequency hopping is configured in one SRS resource, wherein the apparatus is configured to perform SRS frequency hopping with the one SRS resource on a bandwidth that is extended.

18. The apparatus of claim 11, wherein the first configuration information includes a starting resource block of the SRS and a bandwidth of an SRS resource.

19. The apparatus of claim 11, wherein the first configuration information configures an SRS resource, and wherein the SRS resource is outside a currently active BWP.

20. The apparatus of claim 19, wherein an identical subcarrier spacing, SCS, is applied for hops within the SRS resource.
